(19) United States
(12) Patent Application Publication
(10) Pub. No.: US 2015/0022869 A1
(43) Pub. Date: Jan. 22, 2015

(54) DEMOSAICING RGBZ SENSOR

(71) Applicant: Samsung Electronics Co., Ltd., Suwon-si (KR)

(72) Inventors: Lilong SHI, Pasadena, CA (US); Ilia OVSIANNIKOV, Studio City, CA (US)

(21) Appl. No.: 13/944,859

(22) Filed: Jul. 17, 2013

(51) Int. Cl. H04N 1/40; H04N 1/028

(52) U.S. Cl. CPC H04N 1/40012; H04N 1/028
USPC 358/482

(57) ABSTRACT

According to one general aspect, an apparatus may include an image sensor, a monochromatic pixel reconstruction engine, and a demosaicing engine. The image sensor may be configured to capture, at least in part, an image. The image sensor may include a plurality of first sensors configured to generate captured monochromatic pixel values, and a plurality of second sensors configured to not generate captured monochromatic pixel values. The plurality of second sensors may be dispersed amongst the plurality of first sensors such that portions of the image are not captured by the image sensor. The monochromatic pixel reconstruction engine may be configured to estimate an estimated monochromatic pixel value for each second sensor. The demosaicing engine may be configured to, via a color selective adaptive technique, generate a polychromatic image based upon the captured monochromatic pixel values and the estimated monochromatic pixel values.

### TECHNICAL FIELD

This description relates to capturing an image via a sensor, and more specifically, the processing of sampled values to generate an image.

### BACKGROUND

Generally digital image sensors include an array of sensors or sub-sensors. Traditionally, each of these sub-sensors is configured to capture a portion of an image. In this context, the portion of the image captured or sampled by a sub-sensor is referred to as a “pixel”. In this context, the thing (e.g., person, animal, still life, inanimate object, etc.) or things whose likeness is captured in the image is referred to as the “subject” or “subject of the image”. In this context, the term “image” refers to a likeness produced either physically or digitally via the image sensor or by processing the values or portions of the image captured by the sensor or sub-sensors.

Typically, a modern digital image sensor will employ color separation. In such a sensor, each of the sub-sensors is capable of capturing or sampling a single frequency, or optimized to capture a narrow band of frequencies based upon a dominate wavelength. Typically, these wavelengths are referred to as: Red, Green, and Blue. As a result, each pixel of the image is only sampled or captured in one color. Generally, these individual color samples are aggregated via image post-processing or processing to generate an image that includes an array of pixels each having a value that includes a plurality of wavelengths (e.g., a Red-Green-Blue (RGB) vector, cyan, magenta, yellow, and key (black) (CMYK) vector, etc.).

### SUMMARY

According to one general aspect, an apparatus may include an image sensor, a monochromatic pixel reconstruction engine, and a demosaicing engine. The image sensor may be configured to capture, at least in part, an image. The image sensor may include a plurality of first sensors configured to generate captured monochromatic pixel values, and a plurality of second sensors configured to not generate captured monochromatic pixel values. The plurality of second sensors may be dispersed amongst the plurality of first sensors such that portions of the image are not captured by the image sensor. The monochromatic pixel reconstruction engine may be configured to estimate an estimated monochromatic pixel value for each second sensor. The demosaicing engine may be configured to, via a color selective adaptive technique, generate a polychromatic image based upon the captured monochromatic pixel values and the estimated monochromatic pixel values.

According to another general aspect, a system may include an image sensor, a memory, and a processor. The image sensor may be configured to capture, at least in part, an image. The image sensor may include a plurality of first sensors configured to generate captured monochromatic pixel values, and a plurality of second sensors configured to not generate captured monochromatic pixel values. The plurality of second sensors may be dispersed amongst the plurality of first sensors such that portions of the image are not captured by the image sensor. The memory may be configured to store the plurality of captured monochromatic pixel values. The processor may be configured to estimate an estimated monochromatic pixel value for each non-visible light sensor; and generate, via a color selective adaptive technique, a polychromatic image based upon the captured monochromatic pixel values and the estimated monochromatic pixel values.

According to another general aspect, a method may include capturing a mosaiced image of a subject. The mosaiced image may include a plurality of captured monochromatic pixel values, captured via respective first sensors, and a plurality of holes that include missing monochromatic pixel values and does not include captured monochromatic pixel values. The method may include estimating an estimated monochromatic pixel value for each missing monochromatic pixel value. The method may include generating, via a color selective adaptive technique, a polychromatic image based upon the captured monochromatic pixel values and the estimated monochromatic pixel values.

According to another general aspect, a computer program product for capturing an image. The computer program product may be tangibly embodied on a computer-readable medium and may include executable code. When executed, the executable code may be configured to cause an image processing apparatus to capture a mosaiced image of a subject. The mosaiced image includes a plurality of captured monochromatic pixel values, captured via respective visible light pixel sensors configured to detect visible light, and a plurality of holes that include missing monochromatic pixel values and not captured monochromatic pixel values. When executed, the executable code may be configured to cause an image processing apparatus to estimate an estimated monochromatic pixel value for each missing monochromatic pixel value. When executed, the executable code may be configured to cause an image processing apparatus to generate, via a color selective adaptive technique, a polychromatic image based upon the captured monochromatic pixel values and the estimated monochromatic pixel values.

The details of one or more implementations are set forth in the accompanying drawings and the description below. Other features will be apparent from the description and drawings, and from the claims.

A system and/or method for imaging processing, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2a is a block diagram of an example embodiment of a sensor in accordance with the disclosed subject matter.

FIG. 2b is a block diagram of an example embodiment of a sensor in accordance with the disclosed subject matter.

FIG. 3a is a block diagram of an example embodiment of a data structure in accordance with the disclosed subject matter.

FIG. 3b is a block diagram of an example embodiment of a data structure in accordance with the disclosed subject matter.

FIG. 4 is a block diagram of an example embodiment of a data structure in accordance with the disclosed subject matter.

FIG. 5 is a block diagram of an example embodiment of a technique in accordance with the disclosed subject matter.

FIG. 6 is a schematic block diagram of an information processing system which may include devices formed according to principles of the disclosed subject matter.

Like reference symbols in the various drawings indicate like elements.

### DETAILED DESCRIPTION

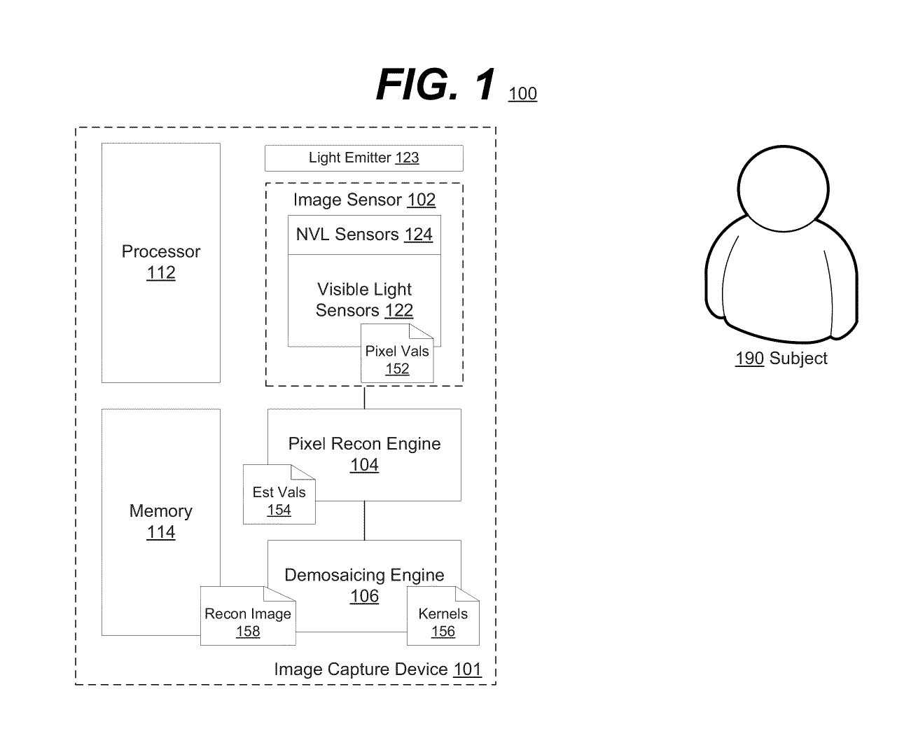

FIG. 1 is a block diagram of an example embodiment of a system 100 in accordance with the disclosed subject matter. In the illustrated embodiment, the system 100 may include an image capture device 101. In various embodiments, the system may also include a subject 190. In this context, the thing (e.g., person, animal, still life, inanimate object, etc.) or things whose likeness is captured by the image capture device 101 is referred to as the “subject” or “subject of the image”.

In various embodiments, the image capture device 101 may include a camera (either still, video, or a combination thereof), a computer or computing device (e.g., a laptop, tablet, smartphone, etc.), a specialized device (e.g., a web camera, a security surveillance device, etc.), part of a more generalized system, etc. It is understood that the above are merely a few illustrative examples to which the disclosed subject matter is not limited.

In various embodiments, the image capture device 101 may include an image sensor 102. In such an embodiment, the image sensor 102 may be configured to capture, at least in part, an image. As described above, in this context, the term “image” refers to a likeness produced either physically or digitally via the image sensor or by processing the values or portions of the image captured by the sensor or sub-sensors. In the illustrated embodiment, the image sensor 102 may be configured to capture, at least in part, an image of the subject 190.

In the illustrated embodiment, the image sensor 102 may include a plurality of visible light (VL) sensors or sub-sensors 122. In such an embodiment, each of the VL sensors 122 may be configured to detect and capture a portion of light within the spectrum generally regarded as visible to the human eye, for example, a wavelength of 380 nanometers (nm) to 740 nm. It is understood that the above is merely one illustrative example to which the disclosed subject matter is not limited.

As described above, in various embodiments, the image sensor 102 may employ color separation. In such an embodiment, the VL sensors 122 may include a number of different VL sensors 122 each configured to detect or capture a particular wavelength of light (or at least be optimized for a particular wavelength). In such an embodiment, these VL sensors 122 may be considered monochromatic, in that they substantially capture one color. In one embodiment, the plurality of NL sensors 122 may include sensors 122 configured to capture Red (e.g., 620-740 nm, etc.), Green (e.g., 520-570 nm, etc.), and Blue (e.g., 450-495 nm, etc.) light. It is understood that the above is merely one illustrative example to which the disclosed subject matter is not limited.

In such an embodiment, each VL sensor 122 may capture a respective portion of the image taken from the subject 190. In various embodiments, each VL sensor 122 may capture this portion of the image as a monochromatic pixel value 152. In various embodiments, this monochromatic pixel value 152 may include a numerical value that represents the intensity of the light captured by the sensor 122. The pixel value 152 may be monochromatic in that a VL sensor 122 configured to capture Green (G) light may only represent the intensity of the Green light, and likewise for Red and Blue.

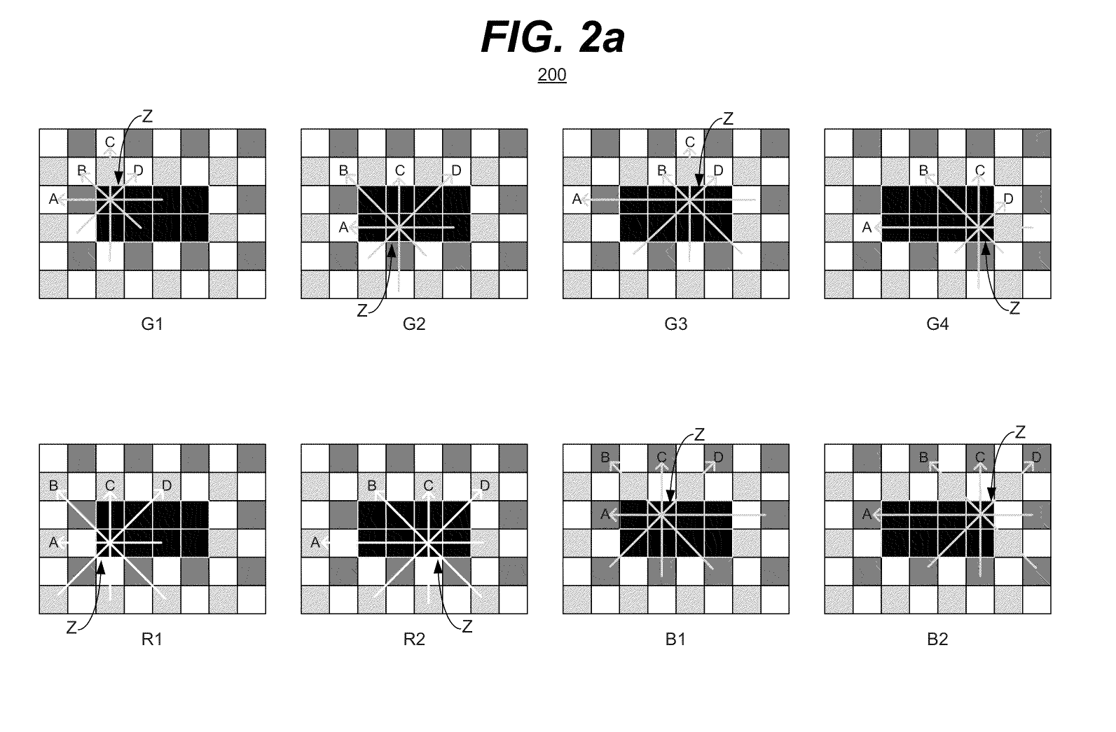

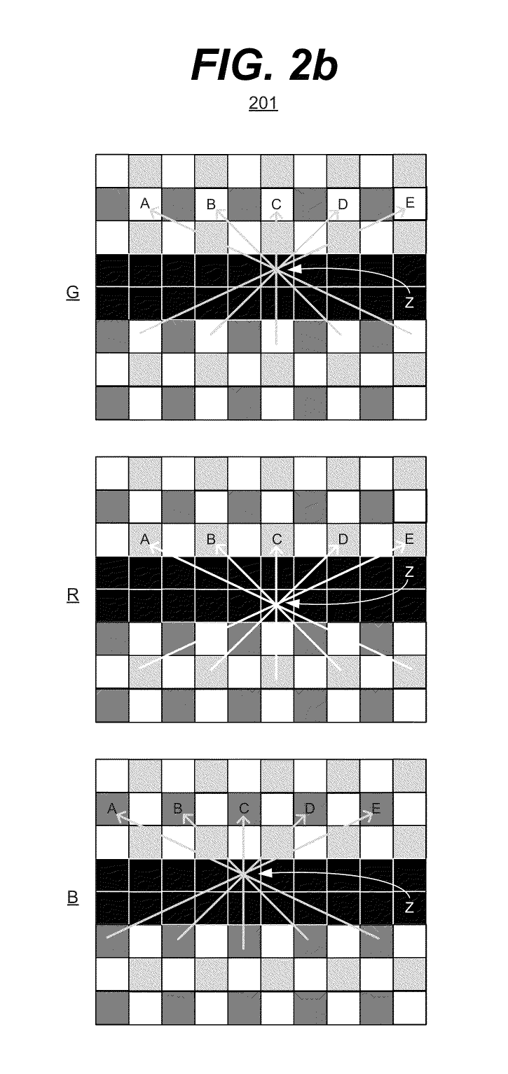

In various embodiments, the plurality or array of VL sensors 122 may be arranged in a predefined pattern or collage. The sensors of FIGS. 2a & 2b illustrate example patterns based upon the Bayer filter, in which the color Green is represented at approximately a 50% rate and Red and Blue are respectively represented at a rate of 25%. It is understood that the above is merely one illustrative example to which the disclosed subject matter is not limited. For example, other patterns of the VL sensors 122 may include the Fujifilm EXR color filter array pattern or the X-Trans filter patter, or other patterns.

Further, in various embodiments, the VL sensors 122 may include polychromatic or panchromatic VL sensors 122 that are configured to capture more than one color of light. It is understood that while the Red-Green-Blue (RGB) color filter array is discussed herein, the disclosed subject matter is not limited to any specific pattern or set of colors. Other sets of colors may include, but are not limited to: cyan, yellow, green, magenta (CYGM); red, green, blue, emerald filter (RGBE); cyan, magenta, yellow, and white (CMYW); or red, green, blue, white (RGBW), etc. In some embodiments, the VL sensors 122 may be arranged in a three-dimensional pattern (or stacked) as opposed to the two-dimensional patterns illustrated by FIGS. 2a and 2b. It is understood that the above are merely a few illustrative examples to which the disclosed subject matter is not limited.

In various embodiments, the image sensor 102 may include a plurality of non-visible light (NVL) sensors 124. In such an embodiment, the NVL sensors 124 may be configured to detect non-visible image information. In some embodiments, each NVL sensor 124 may be configured to capture or store this non-visible image information as non-visible values. In various embodiments, these NVL sensors 124 may be referred to via the letter “Z”, such that the image sensor 102 may be referred to as a RGBZ sensor or similar designation. In some embodiments, the NVL sensors 124 may create “holes” in the image or portions of the image in which monochromatic pixel value 152 is missing or not available.

In one embodiment, the NVL sensors 124 may be configured to detect the distance between the respective NVL sensors 124 and the subject 190. In such an embodiment, the image capture device 101 may include a light emitter 123 configured to emit a light or other signal (e.g., an infrared light, ultraviolet light, radio wave, sound, etc.) at a wavelength that is detectable by the NVL sensors 124. The NVL sensors 124 may be configured to detect that light or signal when it reflects off the subject 190. In another embodiment, the NVL sensors 122 themselves may be configured to emit a light or other signal instead of or in addition to that emitted by the light emitter 123.

In one such embodiment, the NVL sensors 124 may be configured to measure the time-of-flight (ToF) between the emission of the signal and the receipt of the signal. From this, the distance between the NVL sensor 124 and the subject 190 may be determined. In various embodiments, other forms of non-visible image information may be captured by the NVL sensors 124. In some embodiments, non-visible image information may include proximity sensing (PS), inertial sensing, and/or dynamic vision sensing (DVS), etc. or combinations of a plurality of function. It is understood that the above are merely a few illustrative examples to which the disclosed subject matter is not limited.

In some embodiments, the NVL sensors 124 may not be configured to detect or capture visible light. In such an embodiment, the image sensor 102 may have a blind-spot or portion of the image sensor 102 in which the image (or portion thereof) from the subject 190 is not being captured. In such an embodiment, the image sensor 102 may not generate or capture monochromatic pixel values 152 for the portion of the image blocked by the NVL sensors 124.

In various embodiments, the image capture device 101 may include a monochromatic pixel reconstruction engine 104. In some embodiments, the monochromatic pixel reconstruction engine 104 may be configured to estimate an estimated monochromatic pixel value 154 for each NVL sensor 124, as described below in reference to FIGS. 2a and 2b. In some embodiments, if a NVL sensor 124 is the size of a number of VL sensors 122, the monochromatic pixel reconstruction engine 104 may be configured to estimate an estimated monochromatic pixel value 154 for each pixel that the NVL sensor 124 prevents from being captured. For example, if the NVL sensor 124 is the size of eight VL sensors 122, the monochromatic pixel reconstruction engine 104 may be configured to estimate eight estimated monochromatic pixel value 154s. It is understood that the above is merely one illustrative example to which the disclosed subject matter is not limited.

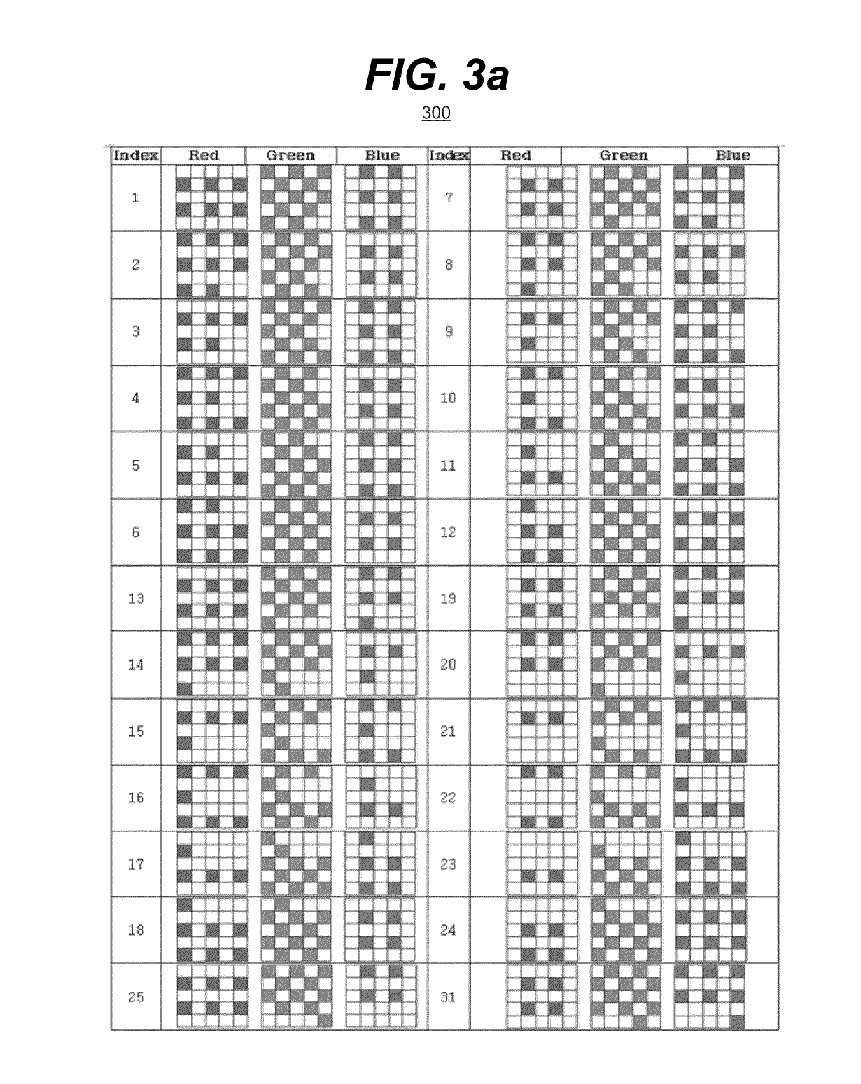

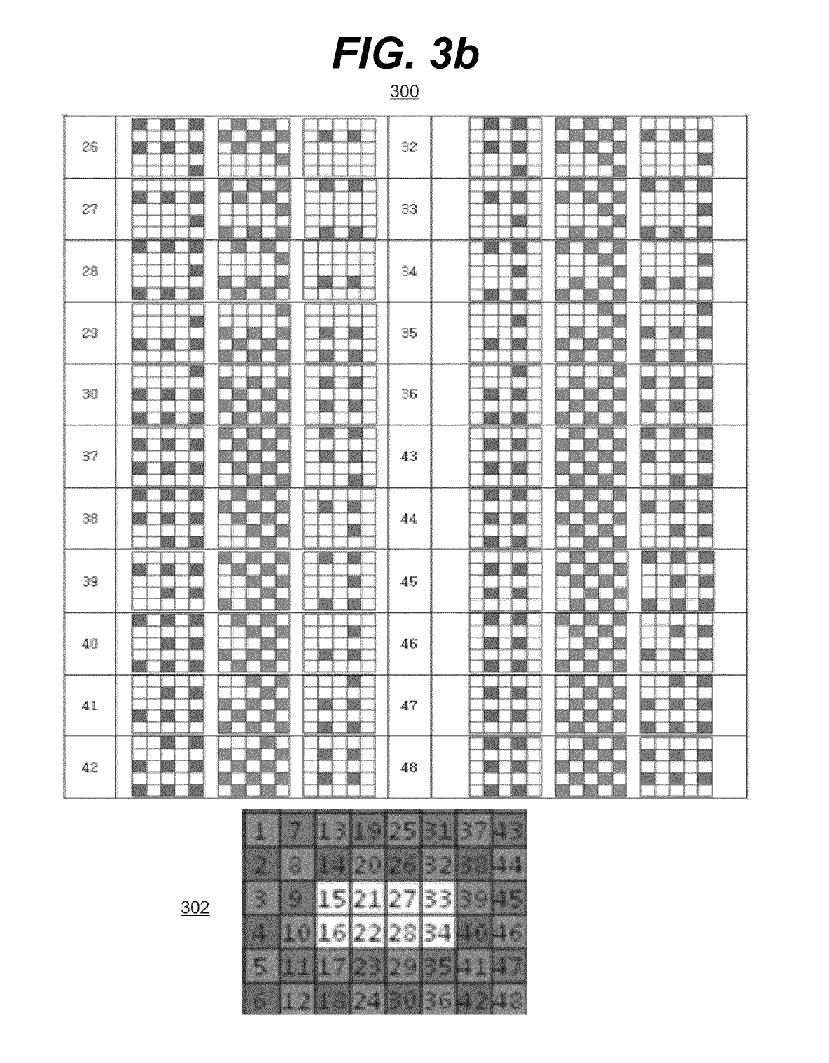

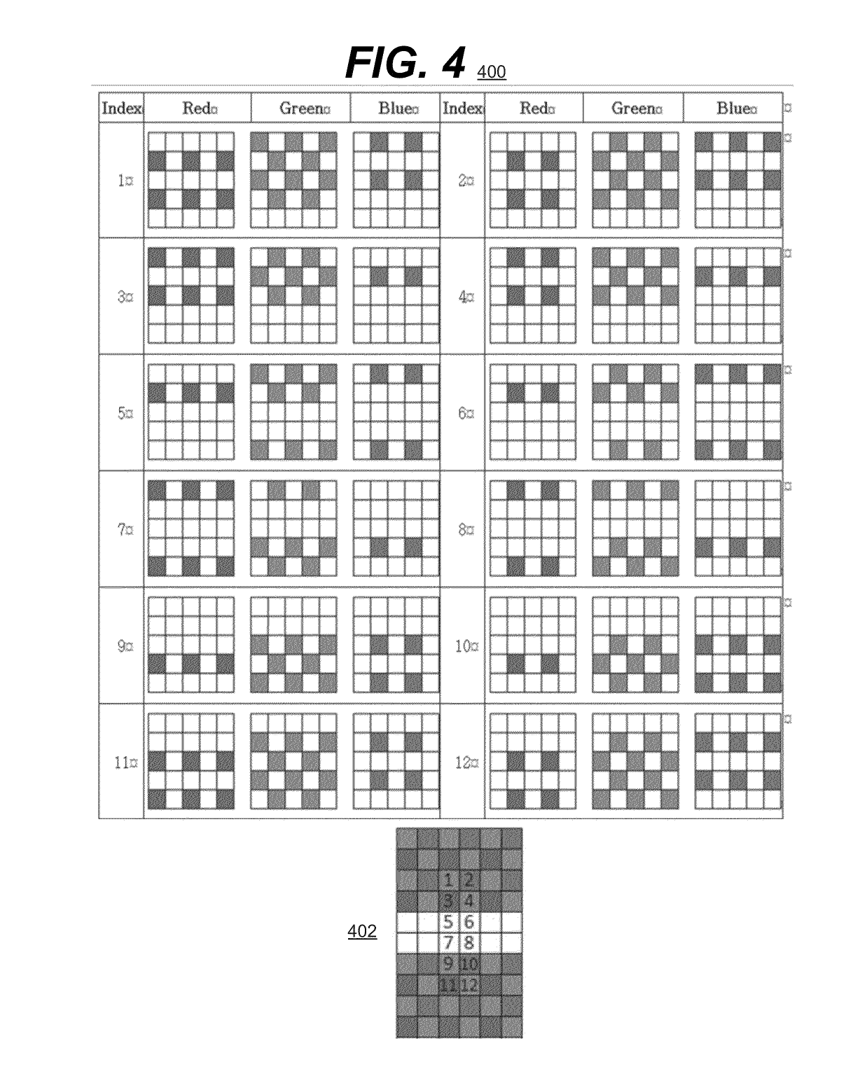

In some embodiments, the image capture device 101 may include a demosaicing engine 106. In one embodiment, the demosaicing engine 106 may be configured to generate a polychromatic or a multiple color reconstructed image 158 based upon the captured monochromatic pixel values 152 and the estimated monochromatic pixel values 154, as described below in reference to FIGS. 3a, 3b, and 4.

In various embodiments, the reconstructed image 158 may include an array of full color or color triplet (e.g., RGB, etc.) values from the spatially under-sampled monochromatic pixel values 152 and 154. In some embodiments, the demosaicing engine 106 may be configured to reconstruct the full color array using or employing one or more kernel patterns or functions 156 to fill-in or generate missing color components. For example, if a given monochromatic pixel value is for the Green color, the corresponding Red and Blue color values may be generated by the demosaicing engine 106 to create a full color or color triplet value for the given pixel.

In some embodiments, the image capture device 101 may include a memory 114 configured to store the reconstructed image 158. In some embodiments, the monochromatic pixel values 152 and 154 may be included in a raw format image and stored within the memory 114.

In various embodiments, the image capture device 101 may include a processor 112. In some embodiments, the processor 112 may include one or both of the pixel reconstruction engine 104 and the demosaicing engine 106. In one embodiment, the processor 112 may control or manage a processing pipeline that includes a plurality of stages of image processing from the capturing of the pixel values 152 via the image sensor 102 to the generating of the reconstructed image 158. In various embodiments, the portion of the processing pipeline after the capturing of the pixel values 152 may be referred to as the post-processing pipeline. In some embodiments, the processor 112 may also be configured to modulate or coordinate outgoing light from a light source (e.g., light emitter 123) with the NVL sensors 124 (e.g., a time of flight capability, etc.). In such an embodiment, the NVL sensor 124 operation may be substantially synchronized with such light modulation. It is understood that the above are merely a few illustrative examples to which the disclosed subject matter is not limited.

FIG. 2a is a block diagram of an example embodiment of a sensor 200 in accordance with the disclosed subject matter. FIG. 2a illustrates eight scenarios or embodiments (G1, G2, G3, G4, R1, R2, B1, B2) of a technique to reconstruct missing monochromatic pixel information not captured by the sensor 200.

In the illustrated embodiment, the sensor 200 may include a plurality of visible light (VL) sensors and a non-visible light (NVL) sensor. In the illustrated embodiment, the VL sensors may include sensors configured to capture Red light (illustrated as light-grey squares or pixels), Green light (illustrated as white squares or pixels), and Blue light (illustrated as dark-grey squares or pixels).

In the illustrated embodiment, the NVL or Z sensor is illustrated as a series of black squares or pixels. In the illustrated embodiment, the NVL or Z sensor may be arranged in a two-dimensional rectangular pattern (e.g., 2 pixels by 4 pixels, etc.). In the illustrated embodiment, the RGB pixels are arranged in a 6×8 Bayer pattern, but are missing 2 Z pixels. Therefore, the traditional Bayer color filter array (CFA) may not be applied directly to the RGBZ sensor 200. Moreover, the RGBZ sensor 200 has fewer known pixels for demosaicing than standard Bayer CFA. As such, the known pixels can be insufficient to approximate missing colors with acceptable accuracy. As a consequence, the reconstructed regions may suffer from artifacts, such as blurry and jaggy edges. It is understood that the above is merely one illustrative example to which the disclosed subject matter is not limited.

In the illustrated embodiment of RGBZ sensor 200, the missing pixel patterns are 2×4 rectangular blocks and the nearby VL pixels captures samples of different color bands (e.g., R, G, B, etc.). In various embodiments, for each missing monochromatic pixel (due to the Z pixel), an edge strength passing through the missing Z pixel via several directions may be estimated or computed. In such an embodiment, the pair of VL pixels that results in the highest correlational edge, corresponding to the minimum pixel difference, may be identified. In one embodiment, the missing Z pixel value may then be linearly interpolated based on it. The diagrams of the eight case (G1, G2, G3, G4, R1, R2, B1, B2) show how the missing green, red and/or blue pixels (caused by the Z pixels) may be estimated.

In the following equations “I” represents the gray-scale un-demosaiced RGBZ image, and the location of the missing monochromatic pixel is represented as “(y, x)”, where y and x represents the row and column respectively. For each Z pixel four edge directions (A, B, C, and D) around the missing monochromatic pixel value I(y, x) are computed.

For each Z pixel, a determination is first made as to what color the Z pixel should be. In various embodiments, this determination may be based upon the color filter array affected by the addition of the Z pixel. In the illustrated embodiment, the cases labeled G1, G2, G3, and G4 each show the computation of Green pixel values as the Z pixel would normally or traditionally be occupied with a VL Green sensor. Likewise, the

R1 and R2 cases show the computation of Red pixel values. And, B1 and B2 cases show the computation of Blue pixel values. It is understood that the above are merely a few illustrative examples to which the disclosed subject matter is not limited.

In various embodiments, an estimate of the missing Z pixel value may be based on the variances of the color difference between existing VL pixel values. In one embodiment, edge based interpolation may be performed. In such an embodiment, this may identify the direction of the highest correlation for directional interpolation.

In various embodiments, the Z pixel directions of scenario G1 may be:

$$\{ \begin{matrix}a = \vert I ( y , x - 2 ) - I ( y , x + 4 ) \vert \\ b = \vert I ( y - 1 , x - 1 ) - I ( y + 2 , x + 2 ) \vert \\ c = \vert I ( y - 2 , x ) - I ( y + 2 , ) \vert \\ d = \vert I ( y - 1 , x + 1 ) - I ( y + 1 , x - 1 ) \vert\end{matrix}$$

In various embodiments, the Z pixel directions of scenario G2 may be:

$$\{ \begin{matrix}a = \vert I ( y , x - 2 ) - I ( y , x + 4 ) \vert \\ b = \vert I ( y - 2 , x - 2 ) - I ( y + 1 , x + 1 ) \vert \\ c = \vert I ( y - 2 , x ) - I ( y + 2 , x ) \vert \\ d = \vert I ( y - 1 , x + 2 ) - I ( y + 1 , x - 1 ) \vert\end{matrix}$$

In various embodiments, the Z pixel directions of scenario G3 may be:

$$\{ \begin{matrix}a = \vert I ( y , x - 4 ) - I ( y , x + 2 ) \vert \\ b = \vert I ( y - 1 , x - 1 ) - I ( y + 2 , x + 2 ) \vert \\ c = \vert I ( y - 2 , x ) - I ( y + 2 , x ) \vert \\ d = \vert I ( y - 1 , x + 1 ) - I ( y + 2 , x - 2 ) \vert\end{matrix}$$

In various embodiments, the Z pixel directions of scenario G4 may be:

$$\{ \begin{matrix}a = \vert I ( y , x - 4 ) - I ( y , x + 2 ) \vert \\ b = \vert I ( y - 2 , x - 2 ) - I ( y + 1 , x + 1 ) \vert \\ c = \vert I ( y - 2 , x ) - I ( y + 2 , x ) \vert \\ d = \vert I ( y - 1 , x + 1 ) - I ( y + 1 , x - 1 ) \vert\end{matrix}$$

In various embodiments, the Z pixel directions of scenarios R1 and B1 may be:

$$\{ \begin{matrix}a = \vert I ( y , x - 2 ) - I ( y , x + 4 ) \vert \\ b = \vert I ( y - 2 , x - 2 ) - I ( y + 2 , x + 2 ) \vert \\ c = \vert I ( y - 2 , x ) - I ( y + 2 , x ) \vert \\ d = \vert I ( y - 2 , x + 2 ) - I ( y + 2 , x - 2 ) \vert\end{matrix}$$

In various embodiments, the Z pixel directions of scenarios R2 and B2 may be:

$$\{ \begin{matrix}a = \vert I ( y , x - 4 ) - I ( y , x + 2 ) \vert \\ b = \vert I ( y - 2 , x - 2 ) - I ( y + 2 , x + 2 ) \vert \\ c = \vert I ( y - 2 , x ) - I ( y + 2 , x ) \vert \\ d = \vert I ( y - 2 , x + 2 ) - I ( y + 2 , x - 2 ) \vert\end{matrix}$$

In some embodiments, the smallest difference among the five directional differences for each Z pixel may represent the least edge or the highest correlation. If this region of the image contains a dominant edge, the interpolation should be performed in the direction of the highest correlation. Otherwise, for a relatively homogeneous region of the image, a bilinear interpolation along vertical direction is performed. For instance, if the highest correlation is a, then the interpolation may be done in the direction of a. Otherwise, a vertical interpolation may be performed. It is understood that the above are merely a few illustrative examples to which the disclosed subject matter is not limited.

The following formulae or rules may be employed to determine the estimated monochromatic pixel value for the respective Z pixels:

In the illustrated embodiment, for the green Z-pixel of scenario G1:

IF min(a,b,c,d)=a, THEN I(y,x)=[2I(y,x−2)+I(y,x+4)]/3

IF min(a,b,c,d)=b, THEN I(y,x)=[2I(y−1,x−1)+I(y+2,x+2)]/3

IF min(a,b,c,d)=d, THEN I(y,x)=[I(y−1,x+1)+I(y+1,x−1)]/2

OTHERWISE, I(y,x)=[I(y−2,x)+I(y+2,x)]/2

In the illustrated embodiment, for the green Z-pixel of scenario G2:

IF min(a,b,c,d)=a, THEN I(y,x)=[2I(y,x−2)+I(y,x+4)]/3

IF min(a,b,c,d)=b, THEN I(y,x)=[I(y−2,x−2)+2I(y+1,x+1)]/3

IF min(a,b,c,d)=d, THEN I(y,x)=[I(y−2,x+2)+2I(y+1,x−1)]/3

OTHERWISE, I(y,x)=[I(y−2,x)+I(y+2,x)]/2

In the illustrated embodiment, for the green Z-pixel of scenario G3:

IF min(a,b,c,d)=a, THEN I(y,x)=[I(y,x−4)+2I(y,x+2)]/3

IF min(a,b,c,d)=b, THEN I(y,x)=[2I(y−1,x−1)+I(y+2,x+2)]/3

IF min(a,b,c,d)=d, THEN I(y,x)=[2I(y−1,x+1)+I(y+2,x−2)]/3

OTHERWISE, I(y,x)=[I(y−2,x)+I(y+2,x)]/2

In the illustrated embodiment, for the green Z-pixel of scenario G4:

IF min(a,b,c,d)=a, THEN I(y,x)=[I(y,x−4)+2I(y,x+2)]/3

IF min(a,b,c,d)=b, THEN I(y,x)=[I(y−2,x−2)+2I(y+1,x+1)]/3

IF min(a,b,c,d)=d, THEN I(y,x)=[I(y−1,x+1)+I(y+1,x−1)]/2

OTHERWISE, I(y,x)=[I(y−2,x)+I(y+2,x)]/2

In the illustrated embodiment, for the red or blue Z-pixels of scenarios R1 and B1:

IF min(a,b,c,d)=a, THEN I(y,x)=[2I(y,x−2)+I(y,x+4)]/3

IF min(a,b,c,d)=b, THEN I(y,x)=[2I(y−2,x−2)+I(y+2,x+2)]/2

IF min(a,b,c,d)=d, THEN I(y,x)=[I(y−2,x+2)+I(y+2,x−2)]/2

OTHERWISE, I(y,x)=[I(y−2,x)+I(y+2,x)]/2

In the illustrated embodiment, for the red or blue Z-pixels of scenarios R2 and B2:

IF min(a,b,c,d)=a, THEN I(y,x)=[I(y,x−4)+I(y,x+2)]/3

IF min(a,b,c,d)=b, THEN I(y,x)=[2I(y−2,x−2)+I(y+2,x+2)]/2

IF min(a,b,c,d)=d, THEN I(y,x)=[I(y−2,x+2)+I(y+2,x−2)]/2

OTHERWISE, I(y,x)=[I(y−2,x)+I(y+2,x)]/2

In various embodiments, once a monochromatic pixel value I(y,x) for each missing or Z-pixel has been generated a more traditional Bayer (or other pattern) image may be created by combining the actual or captured monochromatic pixel values from the VL sensors and the estimated monochromatic pixel values that replace the missing values caused by the NVL sensors. In such an embodiment,

FIG. 2b is a block diagram of an example embodiment of a sensor 201 in accordance with the disclosed subject matter. FIG. 2a illustrates three scenarios or embodiments (G, R, B) of a technique to reconstruct missing monochromatic pixel information not captured by the sensor 201.

In the illustrated embodiment, the sensor 201 may include a plurality of visible light (VL) sensors and a non-visible light (NVL) sensor. In the illustrated embodiment, the VL sensors may include sensors configured to capture Red light (illustrated as light-grey squares or pixels), Green light (illustrated as white squares or pixels), and Blue light (illustrated as dark-grey squares or pixels).

In the illustrated embodiment, the NVL or Z sensor is illustrated as a series of black squares or pixels. In the illustrated embodiment, the NVL or Z sensor may be arranged in a two rows or columns (e.g., a strip of 2 pixels across the image sensor, etc.). In the illustrated embodiment, the RGB pixels are arranged in a Bayer pattern, but are missing a number of pixels due to the NVL sensor. In the illustrated embodiment, the RGBZ CFA of sensor 201 may have 33% less vertical resolution the traditional RGB Bayer CFA. Therefore, the traditional Bayer color filter array (CFA) may not be applied directly to the RGBZ sensor 201, as described above. It is understood that the above is merely one illustrative example to which the disclosed subject matter is not limited.

In the illustrated embodiment of RGBZ sensor 201, for each missing monochromatic pixel (due to the Z pixel), an edge strength passing through the missing Z pixel via several directions may be estimated or computed. In such an embodiment, the pair of VL pixels that results in the highest correlational edge, corresponding to the minimum pixel difference, may be identified. In one embodiment, the missing Z pixel value may then be linearly interpolated based on it. The diagrams of the three cases (G, R, B) show how the missing green, red and/or blue pixels (caused by the Z pixels) may be estimated.

As described above, in various embodiments, for each missing Z pixel at (x,y), the edge strength passing through Z pixel in several directions may be estimated. Then a pair of pixels that results in the highest correlational edge, corresponding to the minimum pixel difference, may be identified and the missing pixel value may be linearly interpolated based on pixel difference.

In the illustrated RGBZ embodiment, the missing lines are 2-pixels wide and the pixels adjacent to the missing lines or NVL sensors include samples of different colors (e.g., R, G, and B). In such an embodiment, the missing colors or VL monochromatic pixel values may occur at regular intervals as dictated by the selected color pattern (e.g., Bayer CFA, etc.). In the illustrated embodiment, three of these missing monochromatic pixel values are shown, but it is understood the pattern may repeat or be applicable other color positions. In the illustrated embodiment, five edge positions are computed.

In various embodiments, the Z pixel directions of scenario G may be:

$$\{ \begin{matrix}a = \vert I ( y - 1 , x - 3 ) - I ( y + 2 , x + 4 ) \vert \\ b = \vert I ( y - 2 , x - 2 ) / 2 + I ( y - 1 , x - 1 ) / 2 - I ( y + 2 , x + 2 ) \vert \\ c = \vert I ( y - 2 , x ) - I ( y + 2 , x ) \vert \\ d = \vert I ( y - 2 , x + 2 ) / 2 + I ( y - 1 , x + 1 ) / 2 - I ( y + 2 , x - 2 ) \vert \\ e = \vert I ( y - 1 , x + 3 ) - I ( y + 2 , x - 4 ) \vert\end{matrix}$$

In such an embodiment, the Z pixel directions of scenarios R and B may be:

$$\{ \begin{matrix}a = \vert I ( y - 2 , x - 4 ) - I ( y + 2 , x + 4 ) \vert \\ b = \vert I ( y - 2 , x - 2 ) - I ( y + 2 , x + 2 ) \vert \\ c = \vert I ( y - 2 , x ) - I ( y + 2 , x ) \vert \\ d = \vert I ( y - 2 , x + 2 ) - I ( y + 2 , x - 2 ) \vert \\ e = \vert I ( y - 2 , x + 4 ) - I ( y + 2 , x - 4 ) \vert\end{matrix}$$

As described above, the smallest difference among the five directional differences may represent the least edge or the highest correlation. In one embodiment, if this region of the RGBZ sensor 201 or image contains a dominant edge, the interpolation may be performed in the direction of the highest correlation. Otherwise, for a relatively homogeneous region of the image, a bilinear interpolation along vertical region may be performed.

To determine if a region of the image contains dominant edges, the difference between the directional difference of the highest correlation and that of the opposite direction of the highest correlation may be computed. If the region has a dominant edge, this difference may be very large. The pairs of opposite directions may be defined as {a, d}, {a, e}, {b, d} and {b, e}. For instance, if the highest correlation is a, then it may be determined whether |a−d|>T and |a−e|>T, where “T” is a predetermined threshold value. In such an embodiment, it may be decided whether it is a dominant directional edge region of the image. If the above condition is satisfied, implying the dominant edge direction is either d or e, the interpolation may be done in the direction of a. Otherwise, a vertical interpolation may be performed. At last, a median filter may be applied to select one of the three values: the interpolated pixel, the pixel of the same color sample above or below. In various embodiments, the selected value may be used or employed as the missing pixel value to prevent the occurrence of artifacts such as bursting pixels.

In one embodiment, the calculation for the missing green Z-pixel may be stated as:

If min(a,b,c,d,e)=a & |a−d|>T & |a−e|>T, I(y,x)=median(I(y−2,x), [2I(y−1,x−3)+I(y+2, x+4)]/3, I(y+2,x))

If min(a,b,c,d,e)=b & |b−d|>T & |b−e|>T, I(y,x)=median(I(y−2,x), [I(y−2,x−2)+2I(y−1,x−1)+I(y+2,x+2)]/4, I(y+2,x))

If min(a,b,c,d,e)=d & |d−a|>T & |d−b|>T, I(y,x)=median(I(y−2,x), [I(y−2,x+2)+2I(y−1,x+1)+I(y+2,x−2)]/4, I(y+2,x))

If min(a,b,c,d,e)=e & |e−a|>T & |e−b|>T, I(y,x)=median(I(y−2,x), [2I(y−1,x+3)+I(y+2,x−4)]/3, I(y+2,x))

Otherwise, I(y,x)=[I(y−2,x)+I(y+2,x)]/2.

Likewise, the calculation for the missing red or blue Z-pixels may be stated as:

If min(a,b,c,d,e)=a & |a−d|>T & |a−e|>T, I(y,x)=median(I(y−2,x), [I(y−2,x−4)+I(y+2,x+4)]/2, I(y+2,x))

If min(a,b,c,d,e)=b & |b−d|>T & |b−e|>T, I(y,x)=median(I(y−2,x), [I(y−2,x−2)+I(y+2,x+2)]/2, I(y+2,x))

If min(a,b,c,d,e)=d & |d−a|>T & |d−b|>T, I(y,x)=median(I(y−2,x), [I(y−2,x+2)+I(y+2,x−2)]/2, I(y+2,x))

If min(a,b,c,d,e)=e & |e−a|>T & |e−b|>T, I(y,x)=median(I(y−2,x), [2I(y−2,x+4)+I(y+2,x−4)]/2, I(y+2,x))

Otherwise, I(y,x)=[I(y−2,x)+I(y+2,x)]/2

As described above, in various embodiments, once a monochromatic pixel value I(y,x) for each missing or Z-pixel has been generated a more traditional Bayer (or other pattern) image may be created by combining the actual or captured monochromatic pixel values from the VL sensors and the estimated monochromatic pixel values that replace the missing values caused by the NVL sensors. In such an embodiment,

In various embodiments, the techniques described above in referred to FIGS. 2a and 2b and/or similar techniques may be employed to reconstruct other missing pixels. In such an embodiment, these pixels or pixel values may be missing or non-existent for a variety of reasons not directly related to the NVL sensors or Z pixels. For example, in some embodiments, such a technique may be employed to reconstruct pixel values missing due to broken, “bad”, or “dead” VL sensors, pixels marked or determined to be invalid, or other reasons. In one embodiment, such a technique may be employed in combination with bad pixel mapping (e.g., detection of faulty pixel circuitry, etc.). In another embodiment, such a technique may be employed for image correction, such as, in combination with image post-processing that does not necessarily involve faulty pixels (e.g., for poorly captured images, etc.). In such an embodiment, one or more pixels or sensors may be fine but for some reason (e.g., dust on the lens, etc.) an image may be blurred or otherwise less than ideal. It is understood that the above are merely a few illustrative examples to which the disclosed subject matter is not limited.

FIGS. 3a and 3b are block diagrams of an example embodiment of a data structure or series of data structures 300 and 302 in accordance with the disclosed subject matter. In the illustrated embodiment, the data structure or series of data structures 300 are displayed across both FIGS. 3a and 3b, due to the limitation of the page size.

In various embodiments, once the reconstructed or estimated monochromatic pixel values have been created for the NVL sensors or Z pixels, the image or in-process version of the image may under do demosaicing. In such an embodiment, the monochromatic pixel values may be converted to or used to create a set of polychromatic pixel values. In one such embodiment, a Green pixel value for a given pixel or portion of the image may be converted to a Red-Green-Blue (RGB) full-color or color triplet pixel value. In one embodiment, these polychromatic pixel values may be combined to may be included within a polychromatic version of the image.

In various embodiments, to avoid using the newly estimated pixels for demosaicing, a bilateral-filter-based approach may interpolate the missing color samples based on weighted average of adaptively selected known or captured pixels (via the VL sensors) from the local neighborhoods or portions of the image around the estimated pixels. The data structures 300 and 301 may be employed during the demosaicing process. Specifically, in one embodiment, data structures 300 and 301 may be employed when processing an image or pixel values resulting from the sensor 200 of FIG. 2a. It is understood that the above is merely one illustrative example to which the disclosed subject matter is not limited.

In various embodiments, a bilateral filter that is a nonlinear filter that does spatial averaging without smoothing edges may be employed. In such an embodiment, bilateral filtering may provide a framework in which interpolation may be performed by selectively weighting pixels in the neighborhood or neighboring region of an estimated pixel value. A mathematical formulae of the bilateral filter is provided below:

$${J}_{s} = {\sum }_{p ∈ Ω} f ( p - s ) g ( {I}_{p} - {I}_{s} ) {I}_{p} / {\sum }_{p ∈ Ω} f ( p - s ) g ( {I}_{p} - {I}_{s} )$$

an alternative version of the formulae may be:

$${J}_{s} = {\int }_{p ∈ Ω} f ( p - s ) g ( {I}_{p} - {I}_{s} ) {I}_{p} / {\int }_{p ∈ Ω} f ( p - s ) g ( {I}_{p} - {I}_{s} )$$

where s is the location of the pixel to be processed, p is the location of neighboring pixels; I and J are the input and output images respectively, and function f and g are the spatial and difference kernel functions, respectively. The kernel function g may be, in one embodiment, sensitive to edges and kernel f may include or perform a blur function. In such an embodiment, the two combined kernels may perform denoising as well as edge sharpening.

Unlike most existing demosaicing methods that use a fixed structure optimized for only horizontal and vertical edge orientations, in the illustrated embodiment, bilateral filtering based demosaic method may allow adaptive selection of pixels for interpolation. This property may be employed when demosaicing a RGBZ sensor because it may allow with one to use only known pixels for interpolating missing color bands.

In various embodiments of the demosaic algorithm, the standard bilateral filter (shown above) may be altered by adding a third color-selective kernel, h, that specifies the neighboring pixels of a certain color. In another embodiment, that involves three color components, the color-selective kernel h may take different forms for different color components (e.g., a red, green and blue component, etc.). Additionally, the color-selective kernel h may be adaptive to different locations in an image. In some embodiments, this may be due or responsive to an irregularity in RGBZ sensor layout.

In the illustrated embodiment, there are 48 positions indexed by 1-48, where the color-selective kernel h may be defined by data structure 302. In the illustrated embodiment, the data structure 302 corresponds with the sensor 200 of FIG. 2a. It is understood that the above is merely one illustrative example to which the disclosed subject matter is not limited.

A full list of all possible outcomes of color-selective kernel h are shown in data structure 300. In the illustrated embodiment, once the index has been determined by reference to data structure 302 the corresponding color-selective kernel, h, may be determined. In the illustrated embodiment, each color-selective kernel, h, includes a sub-kernel or color-specific kernel for each color being generated (e.g., a Red kernel, a Green kernel, a Blue kernel, etc.).

Since the color pattern in the color filter array may be periodic, the index of the color-selective kernel h may be calculated based on its position in the image by:

index of h=mod(x−3,t)×s+mod(y−1,s)+1

where (y,x) is the current position of the pixel to be processed (provided the pixel (1,1) is located at the top-left corner of the image); s and t are the vertical and horizontal distance between two holes, respectively.

In one embodiment of the discrete case, the complete adaptive demosaic filter is formulated as follows:

$${J}^{k} ( y , x ) = w ( y , x ) {\sum }_{m = - L}^{L} {\sum }_{n = - L}^{L} {h}_{y , x}^{k} ( m , n ) f ( m , n ) g ( y , x , m , n ) I ( y + m , x + n ) where , \\ w ( y , x ) = 1 / {\sum }_{m = - L}^{L} {\sum }_{n = - L}^{L} {h}_{y , x}^{k} ( m , n ) f ( m , n ) g ( y , x , m , n )$$

Here, I may be the input full Bayer image obtained from the first step, J^{k} is the demosaiced image of color channel k, with k=red, green or blue. L is the size of the kernel and may be set to 2 in one embodiment. The h_{y,x}^{k} may be the color-selective kernel mask for color k at location (y,x), where the corresponding mask is selected from data structure 300 based on index equation above. As described above, the function f may be the spatial smoothing filter defined as

$$f ( m , n ) = exp ( \frac{{m}^{2} + {n}^{2}}{- 2 {σ}_{h}^{2}} ) / ( \sqrt{2 π} {σ}_{h} )$$

In various embodiments, the kernel function g, may be adaptive to local pixel similarities, may be defined in at least three ways:

$$\begin{matrix}g ( y , x , m , n ) = exp ( \frac{{[ G ( y , x ) - G ( y + m , x + n ) ]}^{2}}{- 2 {σ}_{s}^{2}} ) / ( \sqrt{2 π} {σ}_{s} ) & Technique 1 \\ g ( y , x , m , n ) = exp ( \frac{{[ \begin{matrix}R ( y , x ) - R ( y + m , x + n ) + G ( y , x ) - \\ G ( y + m , x + n ) + B ( y , x ) - B ( y + m , x + n )\end{matrix} ]}^{2}}{- 2 {σ}_{s}^{2}} ) / ( \sqrt{2 π} {σ}_{s} ) & Technique 2 \\ g ( y , x , m , n ) = exp ( \frac{\begin{matrix}{[ \begin{matrix}R ( y , x ) - \\ R ( y + m , x + n )\end{matrix} ]}^{2} + {[ \begin{matrix}G ( y , x ) - \\ G ( y + m , x + n )\end{matrix} ]}^{2} + \\ {[ B ( y , x ) - B ( y + m , x + n ) ]}^{2}\end{matrix}}{( - 2 {σ}_{s}^{2} )} ) / ( \sqrt{2 π} {σ}_{s} ) & Technique 3\end{matrix}$$

where R, G and B may include three intensity images obtained by bilinear interpolating the Bayer image (or other CFA) I.

In various embodiments, a combination of the three intensity images may provide a rough approximation of the full-sized color image. However, in one embodiment, instead of the final image, this image may be only an intermediate image for pixel difference calculation. In such an embodiment, depending on how the pixel difference is computed, one of three of the kernel function g may be employed.

In various embodiments, these three options may include:

1) employing only the green component to compute the difference between two pixels as above in Technique 1;

2) employing the intensity image, by averaging the three color channels, to compute the difference as above in Technique 2; or

3) employing the color image to compute the difference as above in Technique 3.

Finally, the function w may be a normalization factor as the sum of the weights, and σₕ and σₛ are kernel parameters corresponding to spatial and pixel difference variance, respectively.

In one example embodiment, one may wish to reconstruct the full color of a pixel at image location (3,3), a green pixel. First, in such an embodiment, one would select the color-selective kernels from data structure 300 based on the index equation, above. In such an embodiment, the three kernels with index=15 may be selected. Then by the above formulae, the compute kernel function, f(m,n) may be computed. In various embodiments, this computer kernel function may need to only to be computed once for each setting. In various embodiments, the kernel function g may be computed using one of Techniques 1, 2, or 3. By weighted averaging the neighboring pixels selected according to the color-selective kernels (those non-white pixels in the data structure 300), the three color components at (3,3) may be restored.

In some embodiments, note that in the above example, according to the definition of the green color-selective filter, the green component at this pixel location is interpolated even though it is known or actually captured, for denoising to be implicitly performed. In another embodiment, one may not interpolate the color component at a pixel if it's already available in the Bayer image. In such an embodiment, this may occur by checking if the center of the mask is set, e.g., whether h_{y,x}^{k}(3,3) equals 1. It is understood that the above is merely one illustrative example to which the disclosed subject matter is not limited.

FIG. 4 is a block diagram of an example embodiment of a data structures 400 and 402 in accordance with the disclosed subject matter. As described above, in various embodiments, once the reconstructed or estimated monochromatic pixel values have been created for the NVL sensors or Z pixels, the image or in-process version of the image may undergo demosaicing. In such an embodiment, the monochromatic pixel values may be converted to or used to create a set of polychromatic pixel values. In one such embodiment, a Green pixel value for a given pixel or portion of the image may be converted to a Red-Green-Blue (RGB) full-color or color triplet pixel value. In one embodiment, these polychromatic pixel values may be combined to may be included within a polychromatic version of the image.

In various embodiments, to avoid using the newly estimated pixels for demosaicing, a bilateral-filter-based approach may interpolate the missing color samples based on weighted average of adaptively selected known or captured pixels (via the VL sensors) from the local neighborhoods or portions of the image around the estimated pixels. The data structures 400 and 402 may be employed during the demosaicing process, as described above. Specifically, in one embodiment, data structures 400 and 402 may be employed when processing an image or pixel values resulting from the sensor 201 of FIG. 2b. It is understood that the above is merely one illustrative example to which the disclosed subject matter is not limited.

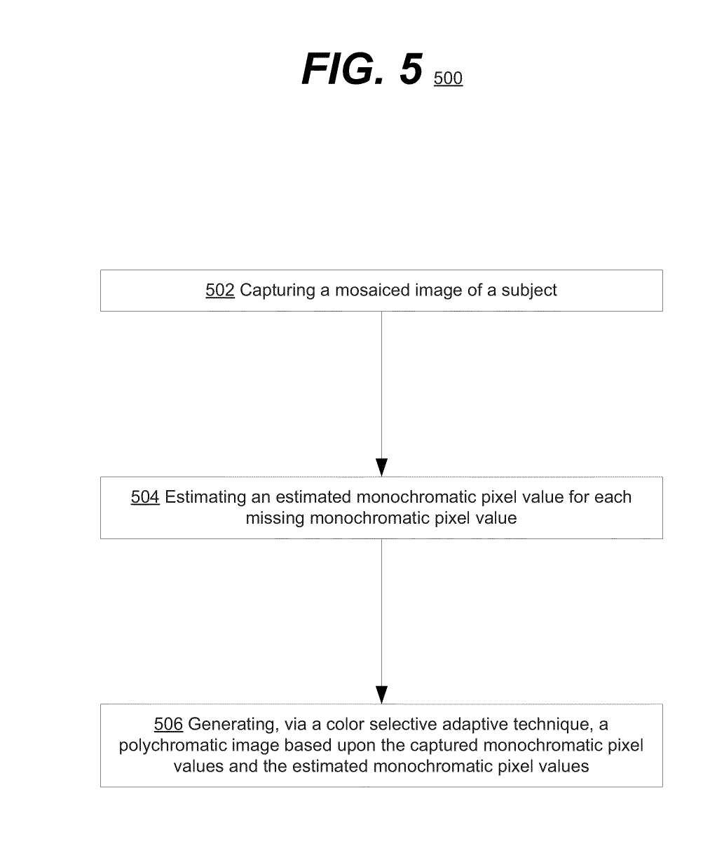

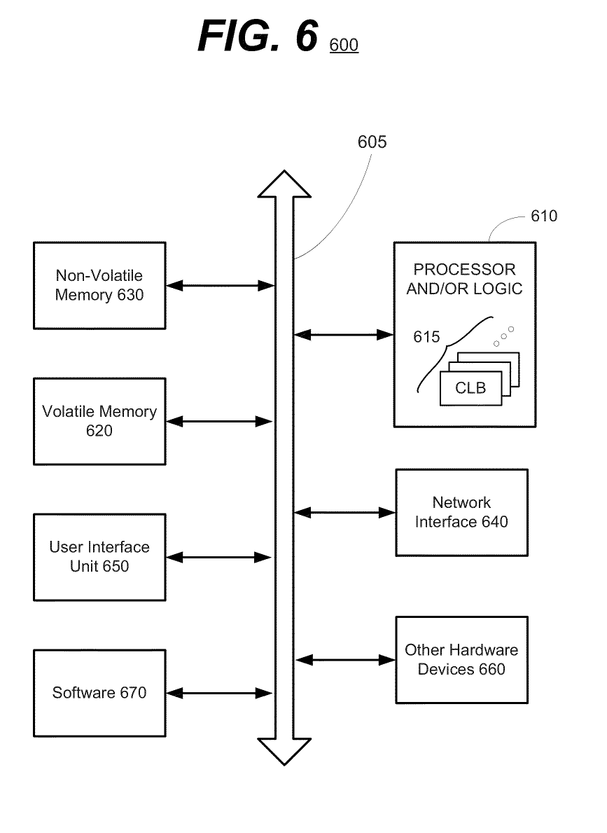

FIG. 5 is a flow chart of an example embodiment of a technique 500 in accordance with the disclosed subject matter. In various embodiments, the technique 500 may be used or produced by the systems such as those of FIG. 1 or 6. Furthermore, portions of technique 500 may be used with the sensors such as that of FIG. 2a or 2b, while another portion of technique 500 may be used with the data structures such as that of FIG. 3a, 3b, or 4. Although, it is understood that the above are merely a few illustrative examples to which the disclosed subject matter is not limited. It is understood that the disclosed subject matter is not limited to the ordering of or number of actions illustrated by technique 500.

Block 502 illustrates that, in one embodiment, a mosaiced image of a subject may be captured, as described above. In one embodiment, the mosaiced image may include a plurality of captured monochromatic pixel values, captured via respective visible light pixel sensors configured to detect visible light, and a plurality of holes that include missing monochromatic pixel values and not captured monochromatic pixel values, as described above. In some embodiments, the missing monochromatic pixel values of each hole may be arranged in a rectangular block, as described above. In various embodiments, one or more of the action(s) illustrated by this Block may be performed by the apparatuses or systems of FIG. 1 or 6, the image sensor 102 of FIG. 1, as described above.

Block 504 illustrates that, in one embodiment, an estimated monochromatic pixel value for each missing monochromatic pixel value may be estimated, as described above. In one embodiment, estimating may include computing a dominate edge direction for each estimated monochromatic pixel value, as described above. In another embodiment, estimating may include computing each estimated monochromatic pixel value based, at least in part, upon a weighted average of a plurality of associated captured monochromatic pixel values, as described above. In yet another embodiment, estimating may include computing each estimated monochromatic pixel value based, at least in part, upon a predetermined threshold value, as described above. In various embodiments, one or more of the action(s) illustrated by this Block may be performed by the apparatuses or systems of FIG. 1 or 6, the processor or pixel reconstruction engine of FIG. 1 or 6, as described above.

Block 506 illustrates that, in one embodiment, a polychromatic image may be generated, via a color selective adaptive technique, based upon the captured monochromatic pixel values and the estimated monochromatic pixel values, as described above. In one embodiment, generating a polychromatic image may include performing a bilateral filtering of the captured monochromatic pixel values and the estimated monochromatic pixel values based upon a color-selective kernel mask, as described above. In another embodiment, generating a polychromatic image may include selecting a set of color-selective kernel masks based upon a position within the image of the pixel value being demosaiced, as described above. In various embodiments, generating a polychromatic image may include generating a polychromatic pixel value employing each of a set of color-selective kernel masks, as described above. In some embodiments, the polychromatic image may include a plurality of polychromatic pixel values, each polychromatic pixel value including a set of monochromatic pixel values, as described above. In such an embodiment, generating a polychromatic image may include, if a captured monochromatic pixel value exists for a polychromatic pixel value generating polychromatic pixel value that includes the captured monochromatic pixel value, as described above. In various embodiments, one or more of the action(s) illustrated by this Block may be performed by the apparatuses or systems of FIG. 1 or 6, the processor or demosaicing engine of FIG. 1 or 6, as described above.

FIG. 6 is a schematic block diagram of an information processing system 600 which may include semiconductor devices formed according to principles of the disclosed subject matter.

Referring to FIG. 6, an information processing system 600 may include one or more of devices constructed according to the principles of the disclosed subject matter. In another embodiment, the information processing system 600 may employ or execute one or more techniques according to the principles of the disclosed subject matter.

In various embodiments, the information processing system 600 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 600 may be used by a user (not shown).

The information processing system 600 according to the disclosed subject matter may further include a central processing unit (CPU), processor or logic 630. In some embodiments, the processor 610 may include one or more functional unit blocks (FUBs) or combinational logic blocks (CLBs) 615. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 600 according to the disclosed subject matter may further include a volatile memory 620 (e.g., a Random Access Memory (RAM), etc.). The information processing system 600 according to the disclosed subject matter may further include a non-volatile memory 630 (e.g., a hard drive, an optical memory, a NAND or Flash memory, etc.). In some embodiments, either the volatile memory 620, the non-volatile memory 630, or a combination or portions thereof may be referred to as a “storage medium”. In various embodiments, the memories 620 and/or 630 may be configured to store data in a semi-permanent or substantially permanent form.

In various embodiments, the information processing system 600 may include one or more network interfaces 640 configured to allow the information processing system 600 to be part of and communicate via a communications network.

Examples of a Wi-Fi protocol may include, but are not limited to: Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to: IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 600 according to the disclosed subject matter may further include a user interface unit 650 (e.g., a display adapter, a haptic interface, a human interface device, etc.). In various embodiments, this user interface unit 650 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 600 may include one or more other hardware components or devices 660 (e.g., a display or monitor, a keyboard, a mouse, a camera, a fingerprint reader, a video processor, etc.). It is understood that the above are merely a few illustrative examples to which the disclosed subject matter is not limited.

The information processing system 600 according to the disclosed subject matter may further include one or more system buses 605. In such an embodiment, the system bus 605 may be configured to communicatively couple the processor 610, the memories 620 and 630, the network interface 640, the user interface unit 650, and one or more hardware components 660. Data processed by the CPU 610 or data inputted from outside of the non-volatile memory 610 may be stored in either the non-volatile memory 610 or the volatile memory 640.

In various embodiments, the information processing system 600 may include or execute one or more software components 670. In some embodiments, the software components 670 may include an operating system (OS) and/or an application. In some embodiments, the OS may be configured to provide one or more services to an application and manage or act as an intermediary between the application and the various hardware components (e.g., the processor 610, a network interface 640, etc.) of the information processing system 600. In such an embodiment, the information processing system 600 may include one or more native applications, which may be installed locally (e.g., within the non-volatile memory 630, etc.) and configured to be executed directly by the processor 610 and directly interact with the OS. In such an embodiment, the native applications may include pre-compiled machine executable code. In some embodiments, the native applications may include a script interpreter (e.g., C shell (csh), AppleScript, AutoHotkey, etc.) or a virtual execution machine (VM) (e.g., the Java Virtual Machine, the Microsoft Common Language Runtime, etc.) that are configured to translate source or object code into executable code which is then executed by the processor 610.

The semiconductor devices described above may be encapsulated using various packaging techniques. For example, semiconductor devices constructed according to principles of the present inventive concepts may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (S SOP) technique, a thin small outline package (TSOP) technique, a thin quad flat package (TQFP) technique, a system in package (SIP) technique, a multi chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

1. An apparatus comprising:
an image sensor configured to capture, at least in part, an image and comprising:
a plurality of first sensors configured to generate captured monochromatic pixel values, and
a plurality of second sensors configured to not generate captured monochromatic pixel values,
wherein the plurality of second sensors are dispersed amongst the plurality of first sensors such that portions of the image are not captured by the image sensor;
a monochromatic pixel reconstruction engine configured to estimate an estimated monochromatic pixel value for each second sensor; and
a demosaicing engine configured to, via a color selective adaptive technique, generate a polychromatic image based upon the captured monochromatic pixel values and the estimated monochromatic pixel values.

2. The apparatus of claim 1, wherein the plurality of second sensors includes a plurality of non-visible light sensors configured to capture a distance between the respective second sensors and a subject of the image; and
wherein the plurality of first sensors include a plurality of visible light sensors configured to detect visible light to generate the captured monochromatic pixel values.

3. The apparatus of claim 1, wherein the plurality of second sensors are arranged in a rectangular block.

4. The apparatus of claim 1, wherein the plurality of second sensors are arranged in rows across the image sensor.

5. The apparatus of claim 1, wherein the monochromatic pixel reconstruction engine is configured to compute a dominate edge direction for each estimated monochromatic pixel value.

6. The apparatus of claim 1, wherein the monochromatic pixel reconstruction engine is configured to compute each estimated monochromatic pixel value based, at least in part, upon a weighted average of a plurality of associated captured monochromatic pixel values.

7. The apparatus of claim 1, wherein the monochromatic pixel reconstruction engine is configured to compute each estimated monochromatic pixel value based, at least in part, upon a predetermined threshold value.

8. The apparatus of claim 1, wherein the monochromatic pixel reconstruction engine is configured to determine which of a plurality of colors is to be a color of the estimated monochromatic pixel value based upon a predetermined color pattern.

9. The apparatus of claim 1, wherein the demosaicing engine is configured to perform a bilateral filtering of the captured monochromatic pixel values and the estimated monochromatic pixel values based upon a color-selective kernel mask.

10. The apparatus of claim 1, wherein the demosaicing engine is configured to select a set of color-selective kernel masks based upon a position within the image of the pixel value being demosaiced.

11. The apparatus of claim 10, wherein the demosaicing engine is configured to generate a polychromatic pixel value using each of the set of color-selective kernel masks.

12. The apparatus of claim 1, wherein the polychromatic image includes a plurality of polychromatic pixel values, each polychromatic pixel value including a set of monochromatic pixel values; and
wherein the demosaicing engine is configured to, if a captured monochromatic pixel value exists for a polychromatic pixel value:
compute a new monochromatic pixel value based upon the color selective adaptive technique, and
generate polychromatic pixel value that includes the new monochromatic pixel value and not the captured monochromatic pixel value.

13. The apparatus of claim 1, wherein the demosaicing engine is configured to:
compute a demosaiced image for each color channel based, at least in part, upon:
a position based color-selective kernel mask,
a spatial smoothing filter kernel, and
a difference kernel configured to measure the difference in intensity between two pixels.

14. The apparatus of claim 1, wherein the demosaicing engine is configured to perform de-noising on the polychromatic image.

15. A system comprising:
an image sensor configured to capture, at least in part, an image and comprising:
a plurality of first sensors configured to generate captured monochromatic pixel values, and
a plurality of second sensors configured to not generate captured monochromatic pixel values,
wherein the plurality of second sensors are dispersed amongst the plurality of first sensors such that portions of the image are not captured by the image sensor;
a memory configured to store the plurality of captured monochromatic pixel values; and
a processor configured to:
estimate an estimated monochromatic pixel value for each non-visible light sensor; and
generate, via a color selective adaptive technique, a polychromatic image based upon the captured monochromatic pixel values and the estimated monochromatic pixel values.

16. The system of claim 15, wherein the processor is configured to compute a dominate edge direction, if any, for each estimated monochromatic pixel value.

17. The system of claim 15, wherein the processor is configured to compute each estimated monochromatic pixel value based, at least in part, upon a weighted average of a plurality of associated captured monochromatic pixel values.

18. The system of claim 15, wherein the processor is configured to compute each estimated monochromatic pixel value based, at least in part, upon a predetermined threshold value.

19. The system of claim 15, wherein the processor is configured to bilaterally filter the captured monochromatic pixel values and the estimated monochromatic pixel values based upon a color-selective kernel mask.

20. The system of claim 15, wherein the processor is configured to select a set of color-selective kernel masks based upon a position within the image of the pixel value being demosaiced.

21. The system of claim 15, wherein the processor is configured to:
compute a demosaiced image for each color channel based, at least in part, upon:
a position based color-selective kernel mask,
a spatial smoothing filter kernel, and
a difference kernel configured to measure the difference in intensity between two pixels.

22. The system of claim 15, wherein the processor is configured to perform de-noising on the polychromatic image.

23-31. (canceled)
